(19) United States
(12) Patent Application Publication
(10) Pub. No.: US 2003/0191686 A1
(43) Pub. Date: Oct. 9, 2003

(54) Idea markets

(76) Inventor: David Andrew Pearson, Huntington Beach, CA (US)

Correspondence Address: DAVID PEARSON, 22102 CAPE MAY LANE, HUNTINGTON BEACH, CA, 92646, US

(21) Appl. No.: 10/116,909

(22) Filed: Apr. 8, 2002

(51) Int. Cl. G06F 17/60

(52) U.S. Cl. 705/14

(57) ABSTRACT

The advertisment of inventions as a means to protect, access value and attempt to market them. The inventions would be described and a percentage of ownership would be offered in the advertisments. The inventor would be identified and a copy of the advertisment can be retained by the inventor for protection. The percentages can be (very small) (so that they are)(affordable).

### ADVERTISING

1. Field

The invention relates to the marketing of inventions

2. Prior Art

Currently, the method for marketing, protecting and accessing value of inventions described here-in is not present in the prior art.

### BRIEF SUMMARY

The object of this invention is to use advertising to protect and access value of inventions and the like. The inventions would be described to the public by advertising as a means for protection. The advertised descriptions would be an (inexpensive) way to protect and access value of the inventions. The advertisments would access value and (attempt to) market the inventions by offering a percentage of them for sale to the public. Copies (or other proof) of the advertisments can be retained by the inventors to use as proof that they are, in fact, the inventors of the inventions.

This invention is a marketing stragety aimed at elminating the need for patents. It is expected that it can make them obsolete and take thier place.

It is anticipated that it can also function as a way to pay for the expenses of obtaining a patent for successful inventions: Small percentages of said inventions can be sold and the revenue can be used to pay for fees, lawyers (and other such expenses). Further, it is anticipated that it can be used to to determine whether a patent on an invention is worth pursueing: If unable to sell percentages, it can be assumed that is not worth it.

The concept can be used for types of ideas for which patents/trademarks are not normally pursued. The inventions mentioned here-in can be ideas for patents or trademarks.

It is expected that the sales of percentages can be done by mail. It is anticipated that contracts can be used. Said contracts can be subject to change. It is a suggestion that they can stipulate that they are not valid unless proof of payment, for example, returned checks or reciepts from the inventors (behalf) are attached to (copies of) the, contracts. It is also suggested that the contracts can be altered if unsatisfactory to the buyer.

### BRIEF DESCRIPTION OF THE DRAWING

FIG. 1 is a front view.

### DETAILED DESCRIPTIONS OF THE DRAWING

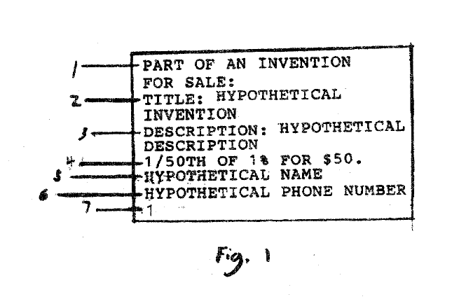

FIG. 1 illustrates an example of an advertisment. The advertisment is subject to change. It is suggested that it can be altered if it is determined that it is unsatisfactory. The embodiment of this example is an ad in a newspaper classified section. The embodiment is subject to change,

1. Advertisment identifier can be a description of what is advertised. Information about ideas that are filed with the USPTO can be included.

2. Title can be a name for the invention.

3. Description can be a description of the invention. Enough detail can be used to adequately explain the invention to the readers so that they would understand it. Information about registration with the USPTO (patent numbers and the like) can be included.

4. Offer can be an offer for legal ownership of one or more percentages of the described invention for a price. The offer can be for one or more shares at a predetermined percentage rate. Percentage rate can be subject to change. Amount of percentage can be subject to change. One hundred percent can be offered. Percentage rate can vary with quantity of percentage purchased. Percentage rate can be described in dollars per percent or percentage. Said price can be subject to change.

5. Identifier can be the name of the inventor. Full names and initails can be used. Identifiers other than names can be used. It can be used to identify the inventor.

6. Phone number can be a phone number. It can be the phone number of the inventor. It can be used to further identify the inventor.

7. Invention number can be a (legal) number assigned to the invention. It is expected that it can have the same effect as a patent number. It is also expected that numbers assigned by that USPTO (patent numbers, filing application numbers) can (also) be used and that information about trademark registration can be included.

It is also expected that the internet and newspaper classified sections and the like can be used to market ideas. It is also expected that internet addresses can be used to (further) identify the inventors.

It is expected that signs [for vehicles that advertise things (other than or along with said vehicles)] that are for sale can be used to market ideas. Said things can include items,services,etc.. It is also expected that such signs can be in the can be in the format of a for sale sign without the words “for sale” on them. It is also expected that said signs can contain (any) erasable information. It is also expected that flyers can be distributed (by mail) to the inventors for the use of marketing ideas.

The possibility of (dedicated) publications for marketing ideas, and (air wave), satillite and cable (t.v., radio) as a means to market ideas is also expected. It is expected that citizens band radio (stations) can be used to market ideas. Such stations can contain a citizen's band radio operator who advertises on such a radio. It is expected that such a radio operator could advertise (in newspaper classified sections and the like) to generate bussiness for citizen's band radio advertisments.

The possibility of using bus stop bench signs, telemarketing and phone line media as a means to market ideas and the marketing of ideas at stores, banks and the like, the use of vending machines and the use of magazines to market ideas is also expected.

It is expected that bussiness for (the described concept of) marketing ideas can be solicited (generated) by advertising(in a phone book).

Further, it is expected that (dedicated) (sub-)sections can be used in newspaper classified sections and the like, by internet advertisers and by the other advertisers [(any other embodiments) that advertise in the format of the described idea marketing concept] for the described advertisements. It is also expected that said sections can include headings that describe the explained idea marketing concept It is also expected that such headings can disclose information about (the intention of) protection for the ideas advertised. It is also expected that they can disclose information about the (expected) probability that the ideas advertised are (either) new or unsuccessful if the readers are unfamiliar with them and that they can also disclose that research is less or not needed because of that. It is also expected that (all of) the advertisers can disclose such information (all of the information listed for said headings included).

It is expected that the described advertisments can include information pertaining to research for the ideas that are advertised in them. It is expected that the ideas can be researched (by the inventors of them, by the advertisers or by third party(s) (research contractors). It is also expected that the advertisments can contain (certified) information about such research. It is also expected that the scope of such is subject to change and that said scope can be (certified and) documented by the advertisments. It is also expected that the research information can be coded and that the coded information can be explained in the described section headings.

(Perferated) pages from (the advertisers) the embodiments that are in the form of newspaper classified sections and the like and pages from internet adverisers that contain one or more of the described advertisments can contain identification information and a date. It is expected that(the described section headings can suggest that)the inventors can retain said pages to protect thier advertised ideas.

It is also expected that (copies of) a (certified) (legal) document(s); [a contracts) that is adequate. for (all of) the proposed transactions can be supplied [for an (extra) fee] (by those who vend and any other embodiments that get involved with) (the described concept for) (the marketing of ideas). It is also expected that said contracts) can stipulate that the described percentages are transferable and whether they are subject to change for advertised ideas that become patented. It is expected that in such scenarios the percentage owners of ideas would become the percentage owners of patents on said ideas. It is expected that The contracts can include information about whether said owners recieve rights to any new material and/or (new) ideas/inventions that result from the application of said patents.

Further, it is expected that (copies of) another document(s); [instructions for making the transactions (legal)] that is adequate for (all of) the proposed transactions, can also be distributed (in such a manner). It is also expected that (such distrbution means can be used for) other (such) documentation (for) (the described concept of) (idea) (marketing). The possibility of the use of said documentation is also expected.

Further, it is also expected that the way that the transactions are done; (for example, in person, by mail or with the internet) (and) (or) the type of transactions is/are subject to change. It is also expected that the scope of advertising; [for example, locally, nationally, world wide or an imbetween of some sort (state wide)] (for) (all of) (the) advertisers is subject to change.

The possibility of phone numbers that charge an extra fee by the minute for (responding to or placing the adverisments of) (the described concept of) idea marketing is expected.

It is expected that the previously described section headings can disclose information to the effect small percentages of ideas can be sold and the revenues can be used to (attempt to) obtain (legal) protection (patent numbers and the like) for them. It is also expected that said headings can include information about any (legal) numbers that are assigned to the ideas advertised (by third parties and/or the advertisers). Further, it is expected that information about patent numbers and the like can be (coded) (and) (explained) in said headings.

It is expected that said headings can disclose information about) the described contracts and/or instructions. It is also expected that said headings can include information to the effect that if a contract appears legal it is legal accompanied by suggestions for the inventors to write thier own contracts. It is expected that said headinqs can include information to the effect that a/the format for the described transactions (can) (be offered) (to) make(s) them legal (for an extra fee). It is expected that said headings can include disclaimers to relinquish responsibility for information or suggestions in them.

It is expected that information (from the USPTO) (patent numbers and the like) in the described advertisments can be coded (or abbreviated) and that said coded information can be explained in said headings. Further, it is expected that said headings can be subject to change.

It is expected that prices for the described advertisments can differ for advertisments that contain different or additional information (presence or absence of patent numbers and the like for instance). It is expected that the cost of the described advertisments can be lowered if it seems to be too high (insufficent amount of customers) or raised if it seems to be too low (if more revenue can be generated by raising it). It is expected that said cost can be left stationary or adjusted in the right or wrong direction (towards optimization) whether (regardless of how) it seems to be and/or is; (too high, optimized, or too low. It is expected that said cost can be subject to change. Further, it is expected that price adjustments for the described advertisments can be advertised (to attempt to) (generate more bussiness) (or more revenue).

It is expected that all items (part numbers) listed for the described advertisments can be optional.

1. A marketing method in which inventions are advertised to the public. The inventions are described and the inventors are identified in the advertisments.
